(19) United States
(12) Patent Application Publication
(10) Pub. No.: US 2025/0226520 A1
(43) Pub. Date: Jul. 10, 2025

(54) BATTERY ASSEMBLY

(71) Applicant: Prime Planet Energy & Solutions, Inc., Tokyo (JP)

(72) Inventor: Yasunori BABA, Kobe-shi (JP)

(21) Appl. No.: 18/981,644

(22) Filed: Dec. 16, 2024

(30) Foreign Application Priority Data
Jan. 4, 2024 (JP) 2024-000101

(51) Int. Cl. H01M 50/342; H01M 50/119; H01M 50/209

(52) U.S. Cl. CPC H01M 50/3425; H01M 50/119; H01M 50/209

(57) ABSTRACT

In a prismatic secondary battery, a battery case includes a first wall portion and a second wall portion facing each other, the first wall portion is provided with a gas-discharge valve that is fractured when pressure in the battery case becomes equal to or more than a first pressure value, an adjacent member has a first surface facing an outer surface of the first wall portion, a space is formed in the adjacent member at a position facing the gas-discharge valve, a groove portion communicating with the space is formed in the first surface of the adjacent member, and when the pressure in the battery case is increased, a portion of the first wall portion is deformed to the outside of the battery case along the groove portion before reaching the first pressure value.

### CROSS REFERENCE TO RELATED APPLICATIONS

This nonprovisional application is based on Japanese Patent Application No. 2024-000101 filed on Jan. 4, 2024 with the Japan Patent Office, the entire contents of which are hereby incorporated by reference.

### BACKGROUND OF THE INVENTION

### Field of the Invention

The present technology relates to a battery assembly.

### Description of the Background Art

Japanese Patent Laying-Open No. 2023-47009 describes a fixing structure between a battery module and a cooling plate, wherein a plurality of recesses are provided in a surface of the cooling plate on the battery module side.

### SUMMARY OF THE INVENTION

Conventionally, when pressure in a battery case is increased, a gas-discharge valve provided at a predetermined position is fractured. From the viewpoint of improving reliability of a battery, a path for gas toward the gas-discharge valve is required to be secured in the battery case.

An object of the present technology is to provide a battery assembly having high reliability.

The present technology provides the following battery assembly.

[1] A battery assembly comprising: a plurality of prismatic secondary batteries arranged in a first direction; and an adjacent member disposed on each of the prismatic secondary batteries, wherein the prismatic secondary battery includes an electrode assembly including a positive electrode and a negative electrode, and a battery case that accommodates the electrode assembly, the battery case includes a first wall portion and a second wall portion facing each other in a second direction orthogonal to the first direction, the first wall portion is provided with a gas-discharge valve that is fractured when pressure in the battery case becomes equal to or more than a first pressure value so as to discharge gas in the battery case to outside of the battery case, the adjacent member has a first surface facing an outer surface of the first wall portion, a space is formed in the adjacent member at a position facing the gas-discharge valve, a groove portion communicating with the space is formed in the first surface of the adjacent member, and when the pressure in the battery case is increased, a portion of the first wall portion is deformed to the outside of the battery case along the groove portion before reaching the first pressure value at which the gas-discharge valve is fractured.

[2] The battery assembly according to [1], wherein the battery case includes a pair of third wall portions facing each other in the first direction, and the plurality of prismatic secondary batteries are disposed such that the third wall portions of the plurality of prismatic secondary batteries face each other.

[3] The battery assembly according to [1] or [2], further comprising a second adjacent member disposed on an outer surface side of the second wall portion.

[4] The battery assembly according to any one of [1] to [3], wherein the groove portion is formed to reach a portion of the first surface that does not overlap with the electrode assembly when viewed in the second direction.

[5] The battery assembly according to any one of [1] to [4], wherein each of the battery case and the adjacent member is composed of a metal, and a thickness of the first wall portion of the battery case is equal to or less than a thickness of a portion of the adjacent member in which the groove portion is not formed.

[6] The battery assembly according to any one of [1] to [5], wherein the battery case includes a case main body provided with an opening, and a sealing plate that seals the opening, and the gas-discharge valve is provided in the case main body.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to one embodiment.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a diagram showing a state in which the secondary battery shown in FIG. 1 is viewed in a direction of arrow IV.

FIG. 5 is a diagram showing a state in which the secondary battery shown in FIG. 1 is viewed in a direction of arrow V.

FIG. 6 is a front cross sectional view of the secondary battery shown in FIG. 1.

FIG. 7 is a cross sectional view of a negative electrode plate.

FIG. 8 is a cross sectional view of a positive electrode plate.

FIG. 9 is a cross sectional view of the secondary battery shown in FIG. 1 along IX-IX.

FIG. 10 is a cross sectional view of the secondary battery shown in FIG. 1 along X-X.

FIG. 11 is a perspective view of a battery assembly according to one embodiment.

FIG. 12 is a front cross sectional view of the secondary battery and plate members included in the battery assembly.

FIG. 13 is a cross sectional view along XIII-XIII in FIG. 12.

FIG. 14 is a front cross sectional view of the secondary battery and the plate members in a state in which internal pressure is increased and a gas-discharge valve is operated.

FIG. 15 is a cross sectional view along XV-XV in FIG. 14.

FIG. 16 is a first diagram showing an exemplary arrangement of groove portions in the plate member.

FIG. 17 is a second diagram showing an exemplary arrangement of the groove portions in the plate member.

FIG. 18 is a third diagram showing an exemplary arrangement of the groove portions in the plate member.

FIG. 19 is a fourth diagram showing an exemplary arrangement of the groove portions in the plate member.

FIG. 20 is a fifth diagram showing an exemplary arrangement of the groove portions in the plate member.

FIG. 21 is a first diagram showing an exemplary cross sectional shape of each groove portion.

FIG. 22 is a second diagram showing an exemplary cross sectional shape of each groove portion.

FIG. 23 is a third diagram showing an exemplary cross sectional shape of each groove portion.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “secondary battery” is not limited to a lithium ion battery, and may include other secondary batteries such as a nickel-metal hydride battery and a sodium-ion battery. In the present specification, the term “electrode” may collectively represent a positive electrode and a negative electrode.

It should be noted that in each of the figures, an X direction is defined as a long-side direction of a stacked surface of a stacked type electrode assembly included in the secondary battery. Further, a Y direction is defined as a short-side direction of the electrode assembly when viewed in the X direction, and a Z direction is defined as a long-side direction of the electrode assembly when viewed in the X direction. In order to facilitate understanding of the invention, the size of each configuration in the figures may be illustrated to be changed from its actual size.

In the specification of the present application, a first direction (Y direction) may be referred to as a “thickness direction” of the secondary battery or a case main body, a second direction (Z direction) may be referred to as a “height direction” of the secondary battery or the case main body, and a third direction (X direction) may be referred to as a “width direction” of the secondary battery or the case main body.

### (Overall Configuration of Battery)

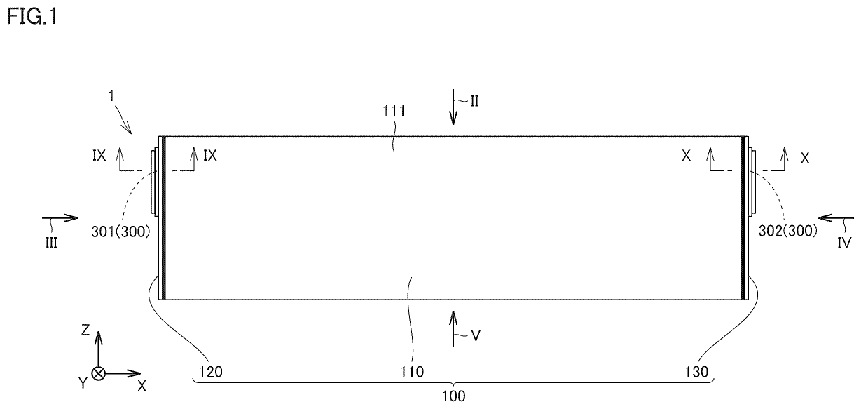

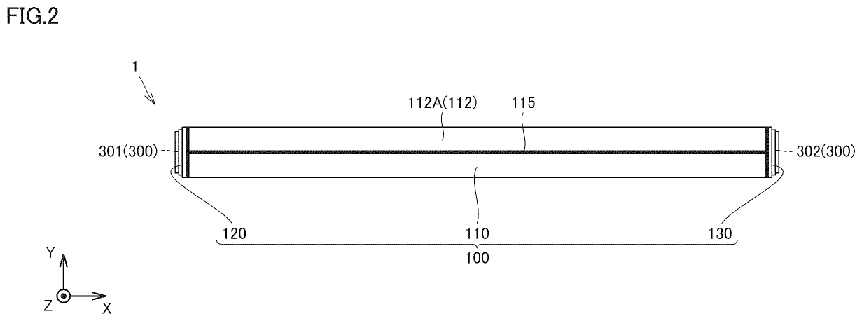

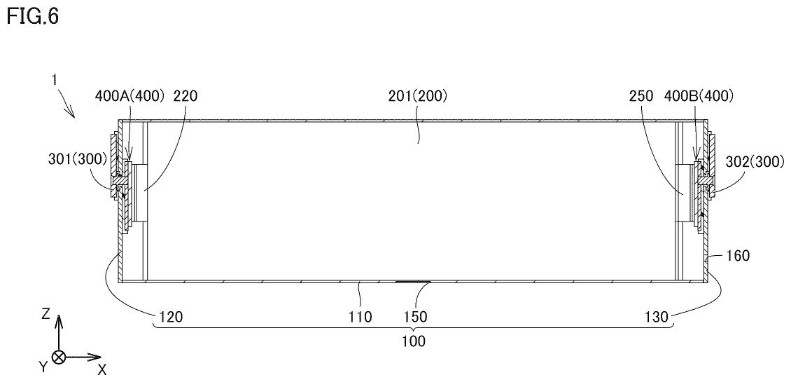

FIG. 1 is a front view of a secondary battery 1 according to one embodiment. FIGS. 2 to 5 are diagrams showing states of secondary battery 1 (non-aqueous electrolyte secondary battery) shown in FIG. 1 when viewed in directions of arrows II, III, IV, and V respectively. FIG. 6 is a front cross sectional view of secondary battery 1 shown in FIG. 1.

Secondary battery 1 can be mounted on a battery electric vehicle (BEV), a plug-in hybrid electric vehicle (PHEV), a hybrid electric vehicle (HEV), or the like. It should be noted that the purpose of use of secondary battery 1 is not limited to the use on a vehicle.

As shown in FIGS. 1 to 6, secondary battery 1 (prismatic secondary battery) includes a case 100 (battery case), an electrode assembly 200, electrode terminals 300, and current collectors 400. Case 100 includes a case main body 110, a sealing plate 120, and a sealing plate 130.

When forming a battery assembly including secondary battery 1, a plurality of secondary batteries 1 are stacked in the thickness direction of each of the plurality of secondary batteries 1. Secondary batteries 1 stacked may be restrained in the stacking direction (Y direction) by a restraint member to form a battery module, or the battery assembly may be directly supported by a side surface of a case of a battery pack without using the restraint member.

Case main body 110 is constituted of a member having a tubular shape, preferably, a prismatic tubular shape. Thus, secondary battery 1 having a prismatic shape is obtained. Case main body 110 is composed of a metal. Specifically, case main body 110 is composed of aluminum, an aluminum alloy, iron, an iron alloy, or the like.

As shown in FIGS. 1 and 2, sealing plate 120 and sealing plate 130 are provided at respective end portions of the case main body. Case main body 110 can be formed to have a prismatic tubular shape in, for example, the following manner: end sides of a plate-shaped member having been bent are brought into abutment with each other (joining portion 115 illustrated in FIG. 2) and are joined together (for example, laser welding). Each of the corners of the “prismatic tubular shape” may have a shape with a curvature.

In the present embodiment, case main body 110 is formed to be longer in the width direction (X direction) of secondary battery 1 than in each of the thickness direction (Y direction) and the height direction (Z direction) of secondary battery 1. The size (width) of case main body 110 in the X direction is preferably about 30 cm or more. In this way, secondary battery 1 can be formed to have a relatively large size (high capacity). The size (height) of case main body 110 in the Z direction is preferably about 20 cm or less, more preferably about 15 cm or less, and further preferably about 10 cm or less. Thus, (low-height) secondary battery 1 having a relatively low height can be formed, thus resulting in improved ease of mounting on a vehicle, for example.

Case main body 110 includes a pair of first side surface portions 111 and a pair of second side surface portions 112. The pair of first side surface portions 111 constitute parts of the side surfaces of case 100. The pair of second side surface portions 112 constitute the bottom surface portion and upper surface portion of case 100. The pair of first side surface portions 111 and the pair of second side surface portions 112 are provided to intersect each other. The pair of first side surface portions 111 and the pair of second side surface portions 112 are connected at their respective end portions. Each of the pair of first side surface portions 111 desirably has an area larger than that of each of the pair of second side surface portions 112.

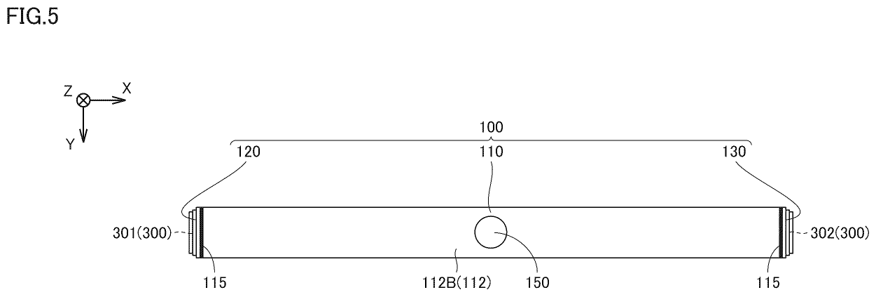

As shown in FIG. 5, a gas-discharge valve 150 is provided in one second side surface portion 112B (first wall portion) of the pair of second side surface portions 112. In the example of FIG. 5, gas-discharge valve 150 is provided at a central portion of secondary battery 1 in the width direction (X direction). In the present embodiment, gas-discharge valve 150 is provided in a wall surface different from sealing plates 120, 130. The position and shape of gas-discharge valve 150 can be appropriately changed.

The thickness of the plate-shaped member in gas-discharge valve 150 is thinner than the thickness of the plate-shaped member of case main body 110 other than gas-discharge valve 150. Thus, when the pressure in case 100 becomes equal to or more than a predetermined value, gas-discharge valve 150 is fractured prior to the other portions of case main body 110, thereby discharging the gas in case 100 to the outside.

As shown in FIG. 2, joining portion 115 is formed at the other second side surface portion 112A (second wall portion) of the pair of second side surface portions 112. Joining portion 115 extends in the width direction (X direction) of secondary battery 1. At joining portion 115, the end sides of the plate-shaped member of case main body 110 are joined to each other.

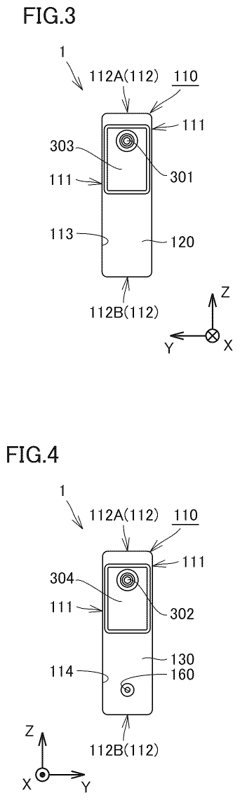

As shown in FIG. 3, an opening 113 (first opening) is provided at an end portion of case main body 110 on a first side in the X direction. Opening 113 is sealed by sealing plate 120. Joining portion 115 is formed at opening 113 so as to seal opening 113. Each of opening 113 and sealing plate 120 has a substantially rectangular shape in which the Y direction corresponds to its short-side direction and the Z direction corresponds to its long-side direction. It should be noted that the substantially rectangular shape includes a rectangular shape or a generally rectangular shape such as a rectangular shape having corners each with a curvature.

Sealing plate 120 (first sealing plate) is provided with a negative electrode terminal 301. The position of negative electrode terminal 301 can be appropriately changed.

As shown in FIG. 4, an opening 114 (second opening) is provided at an end portion of case main body 110 on a second side opposite to the first side in the X direction. That is, opening 114 is located at an end portion opposite to opening 113, and openings 113, 114 face each other. Opening 114 is sealed by sealing plate 130. Joining portion 115 is formed at opening 114 so as to seal opening 114. Each of opening 114 and sealing plate 130 has a substantially rectangular shape in which the Y direction corresponds to its short-side direction and the Z direction corresponds to its long-side direction.

Sealing plate 130 (second sealing plate) is provided with a positive electrode terminal 302 and an injection hole 140. The positions of positive electrode terminal 302 and injection hole 140 can be appropriately changed.

Each of sealing plate 120 and sealing plate 130 is composed of a metal. Specifically, each of sealing plate 120 and sealing plate 130 is composed of aluminum, an aluminum alloy, iron, an iron alloy, or the like.

Negative electrode terminal 301 (first electrode terminal) is electrically connected to a negative electrode of electrode assembly 200. Negative electrode terminal 301 is attached to sealing plate 120, i.e., case 100.

Positive electrode terminal 302 (second electrode terminal) is electrically connected to a positive electrode of electrode assembly 200. Positive electrode terminal 302 is attached to sealing plate 130, i.e., case 100.

Negative electrode terminal 301 is composed of a conductive material (more specifically, a metal), and can be composed of copper, a copper alloy, or the like, for example. A portion or layer composed of aluminum or an aluminum alloy may be provided at a portion of an outer surface of negative electrode terminal 301.

Positive electrode terminal 302 is composed of a conductive material (more specifically, a metal), and can be composed of aluminum, an aluminum alloy, or the like, for example.

Injection hole 140 is sealed by a sealing member (not shown). As the sealing member, for example, a blind rivet or another metal member can be used.

Electrode assembly 200 is an electrode assembly having a flat shape and having a below-described positive electrode plate and a below-described negative electrode plate stacked on each other. It should be noted that electrode assembly 200 may include a plurality of electrode assemblies.

As shown in FIG. 6, case 100 accommodates electrode assembly 200. FIG. 6 illustrates a first electrode assembly 201 described below. First electrode assembly 201 is accommodated in case 100 such that the long-side direction thereof is parallel to the X direction.

Specifically, one or a plurality of the stacked type electrode assemblies and an electrolyte solution (electrolyte) (not shown) are accommodated inside a below-described insulating sheet 700 disposed in case 100. As the electrolyte solution (non-aqueous electrolyte solution), it is possible to use, for example, a solution obtained by dissolving LiPF₆ at a concentration of 1.2 mol/L in a non-aqueous solvent obtained by mixing ethylene carbonate (EC), ethyl methyl carbonate (EMC), and dimethyl carbonate (DMC) at a volume ratio (25° C.) of 30:30:40.

First electrode assembly 201 includes a main body portion having a substantially rectangular shape, a negative electrode tab group 220 (first electrode tab group), and a positive electrode tab group 250 (second electrode tab group).

The main body portion is constituted of a below-described negative electrode plate 210 and a below-described positive electrode plate 240. Negative electrode tab group 220 is located at an end portion of first electrode assembly 201 on the first side with respect to the main body portion thereof in the X direction. The first side in the present embodiment is the sealing plate 120 side. Positive electrode tab group 250 is located at an end portion of first electrode assembly 201 on the second side with respect to the main body portion thereof in the X direction. The second side in the present embodiment is the sealing plate 130 side.

Each of negative electrode tab group 220 and positive electrode tab group 250 is formed to protrude from a central portion of electrode assembly 200 toward sealing plate 120 or sealing plate 130.

Current collectors 400 include a negative electrode current collector 400A and a positive electrode current collector 400B. Each of negative electrode current collector 400A and positive electrode current collector 400B is constituted of a plate-shaped member. Electrode assembly 200 is electrically connected to negative electrode terminal 301 and positive electrode terminal 302 through current collectors 400.

Negative electrode current collector 400A is disposed on sealing plate 120 with an insulating member composed of a resin being interposed therebetween. Negative electrode current collector 400A is electrically connected to negative electrode tab group 220 and negative electrode terminal 301. Negative electrode current collector 400A is composed of a conductive material (more specifically, a metal), and can be composed of copper, a copper alloy, or the like, for example. It should be noted that details of negative electrode current collector 400A will be described later.

Positive electrode current collector 400B is disposed on sealing plate 130 with an insulating member composed of a resin being interposed therebetween. Positive electrode current collector 400B is electrically connected to positive electrode tab group 250 and positive electrode terminal 302. Positive electrode current collector 400B is composed of a conductive material (more specifically, a metal), and can be composed of aluminum, an aluminum alloy, or the like, for example. It should be noted that positive electrode tab group 250 may be electrically connected to sealing plate 130 directly or via positive electrode current collector 400B. In this case, sealing plate 130 may serve as positive electrode terminal 302. Moreover, details of positive electrode current collector 400B will be described later.

### (Configuration of Electrode Assembly 200)

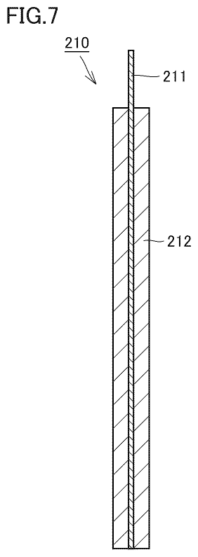

FIG. 7 is a cross sectional view of negative electrode plate 210 included in electrode assembly 200. As shown in FIG. 7, negative electrode plate 210 includes a negative electrode core body 211 and a negative electrode active material layer 212.

A negative electrode tab 230 constituted of negative electrode core body 211 to form negative electrode tab group 220 is provided at one end portion, in the width direction, of negative electrode plate 210. When negative electrode plates 210 are stacked, a plurality of negative electrode tabs 230 are stacked to form negative electrode tab group 220. The length of each of the plurality of negative electrode tabs 230 in the plurality of negative electrode plates 210 in the protruding direction is appropriately adjusted in consideration of the state in which negative electrode tab group 220 is connected to negative electrode current collector 400A. It should be noted that the position and shape of negative electrode tab 230 can be appropriately changed.

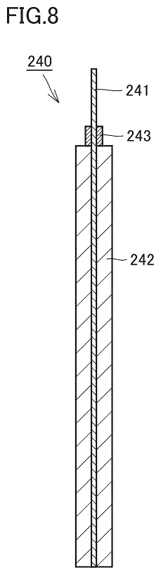

FIG. 8 is a cross sectional view of positive electrode plate 240 included in electrode assembly 200. As shown in FIG. 8, positive electrode plate 240 includes a positive electrode core body 241 and a positive electrode active material layer 242.

A positive electrode tab 260 (second electrode tab) constituted of positive electrode core body 241 to form positive electrode tab group 250 is provided at one end portion, in the width direction, of positive electrode plate 240. When positive electrode plates 240 are stacked, a plurality of positive electrode tabs 260 are stacked to form positive electrode tab group 250. The length of each of positive electrode tabs 260 in the plurality of positive electrode plates 240 in the protruding direction is appropriately adjusted in consideration of the state in which positive electrode tab group 250 is connected to positive electrode current collector 400B. It should be noted that the position and shape of positive electrode tab 260 can be appropriately changed.

A positive electrode protective layer 243 is provided at the root of positive electrode tab 260. Positive electrode protective layer 243 may not necessarily be provided at the root of positive electrode tab 260.

Electrode assembly 200 may be a wound type electrode assembly in which a negative electrode plate 210 having an elongated shape and a positive electrode plate 240 having an elongated shape are stacked and wound with a separator (not shown) being interposed therebetween, or may be a stacked type electrode assembly in which a negative electrode plate 210 having a rectangular shape and a positive electrode plate 240 having a rectangular shape are alternately stacked. The separator can be constituted of, for example, a microporous membrane composed of polyolefin.

(Connection Structure between Electrode Assembly 200 and Current Collector 400)

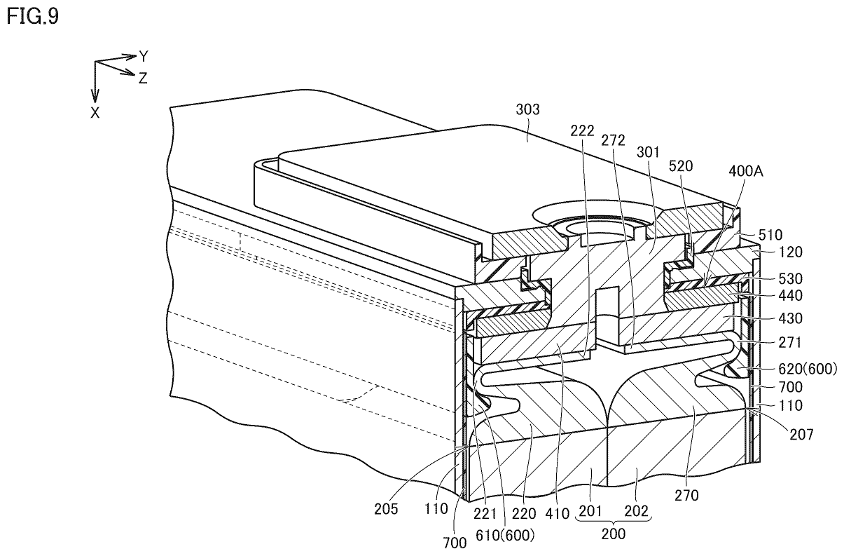

FIG. 9 is a cross sectional view of the secondary battery shown in FIG. 1 along IX-IX. As shown in FIG. 9, electrode assembly 200 includes first electrode assembly 201 and a second electrode assembly 202. Each of first electrode assembly 201 and second electrode assembly 202 includes a positive electrode (second electrode) and a negative electrode (first electrode). It should be noted that electrode assembly 200 may be constituted of one electrode assembly or may be constituted of three or more electrode assemblies.

Electrode assembly 200 is formed by overlapping first electrode assembly 201 and second electrode assembly 202 with each other. First electrode assembly 201 and second electrode assembly 202 are arranged side by side in the thickness direction (Y direction) of each of first electrode assembly 201 and second electrode assembly 202.

First electrode assembly 201 includes negative electrode tab group 220. Negative electrode tab group 220 is electrically connected to a current collector 410 (negative electrode current collector) at its first end portion 205 in the X direction. Second electrode assembly 202 includes a negative electrode tab group 270. Negative electrode tab group 270 is electrically connected to a current collector 430 (negative electrode current collector) at its third end portion 207 in the X direction.

Negative electrode tab group 220 has a curved portion 221 and a tip portion 222. Curved portion 221 is a portion at which negative electrode tab group 220 is curved on the side, on which the first electrode is connected, with respect to tip portion 222. Tip portion 222 is a portion located at an end portion of negative electrode tab group 220 on the side opposite to the side on which the first electrode is connected.

Negative electrode tab group 270 has a curved portion 271 and a tip portion 272. Curved portion 271 is a portion at which negative electrode tab group 270 is curved on the side, on which the first electrode is connected, with respect to tip portion 272. Tip portion 272 is a portion located at an end portion of negative electrode tab group 270 on the side opposite to the side on which the first electrode is connected.

Negative electrode tab group 220 and negative electrode tab group 270 are curved in opposite directions such that tip portions 222, 272 are close to each other. It should be noted that tip portions 222, 272 are separated from each other in the present embodiment; however, it is not limited to this configuration, and tip portions 222, 272 may be in contact with each other.

Negative electrode current collector 400A electrically connects negative electrode terminal 301 to negative electrode tab group 220 and negative electrode tab group 270. Negative electrode current collector 400A in the present embodiment is connected to negative electrode terminal 301 between electrode assembly 200 and sealing plate 120.

Negative electrode current collector 400A includes current collector 410, current collector 430, and a current collector 440.

Current collector 410 is a plate-shaped member. Current collector 410 has a long-side direction in the Z direction and a short-side direction in the Y direction. Current collector 430 is a plate-shaped member. Current collector 430 has a long-side direction in the Z direction and a short-side direction in the Y direction. Current collector 410 and current collector 430 are arranged side by side in parallel in the X direction. In this way, current collector 410 and current collector 430 are constituted of separate components.

Negative electrode tab groups 220, 270 are respectively joined to current collectors 410, 430. Negative electrode tab groups 220, 270 and current collectors 410, 430 can be joined by, for example, ultrasonic welding, resistance welding, laser welding, swaging, or the like. In the present embodiment, negative electrode tab group 220 and current collector 410 are joined by ultrasonic joining, and negative electrode tab group 270 and current collector 430 are joined by ultrasonic joining, for example.

Current collector 440 is joined to each of current collector 410 and current collector 430 at a joining location (not shown) located at its end portion in the Z direction. Current collector 440 is connected to negative electrode terminal 301. The connection between current collector 440 and negative electrode terminal 301 can be formed by swaging and/or welding, for example.

Negative electrode terminal 301 is provided to be exposed to the outside of sealing plate 120 and reach current collector 440 of negative electrode current collector 400A provided on the inner surface side of sealing plate 120. Negative electrode terminal 301 is connected to a plate-shaped member 303.

Plate-shaped member 303 is located on the outer side with respect to sealing plate 120. Plate-shaped member 303 is disposed along sealing plate 120. Plate-shaped member 303 has electric conductivity. Plate-shaped member 303 is disposed to secure an area of connection with a bus bar or the like that electrically connects secondary battery 1 and another secondary battery adjacent thereto. The connection between negative electrode terminal 301 and plate-shaped member 303 can be formed by, for example, laser welding or the like.

An insulating member 510 is disposed between plate-shaped member 303 and sealing plate 120. An insulating member 520 is disposed between negative electrode terminal 301 and sealing plate 120. An insulating member 530 is disposed between current collector 440 and sealing plate 120.

It should be noted that negative electrode terminal 301 may be electrically connected to sealing plate 120. Further, sealing plate 120 may function as negative electrode terminal 301.

A spacer 600 is disposed between sealing plate 120 and the main body portion (negative electrode tab group 220 is not included) of electrode assembly 200. Spacer 600 is composed of a resin member having an insulating property. Spacer 600 includes a first component 610 and a second component 620. First component 610 and second component 620 are engaged with each other at engagement portions (not shown) at both ends in the Z direction.

Each of first component 610 and second component 620 protrudes in the Y direction at its end portion side on the electrode assembly 200 side in the X direction. Thus, spacer 600 functions as a guide to facilitate curving of curved portions 221, 271 when forming curved portions 221, 271.

Insulating sheet 700 (electrode assembly holder) composed of a resin is disposed between electrode assembly 200 and case main body 110. Insulating sheet 700 may be composed of, for example, a resin. More specifically, the material of insulating sheet 700 is, for example, polypropylene (PP), polyethylene terephthalate (PET), polyphenylene sulfide (PPS), polyimide (PI), or polyolefin (PO).

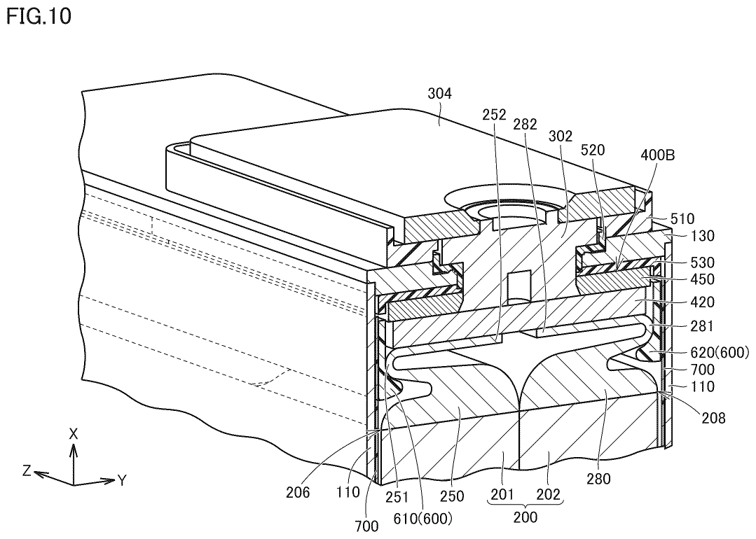

FIG. 10 is a cross sectional view of the secondary battery shown in FIG. 1 along X-X. The connection structure between electrode assembly 200 and current collector 400 on the positive electrode side of secondary battery 1 according to the present embodiment is different from that of the configuration on the negative electrode side in the following point: a portion corresponding to current collector 410 and current collector 430 on the negative electrode side is constituted of a single component (current collector 420).

First electrode assembly 201 includes positive electrode tab group 250. Positive electrode tab group 250 is electrically connected to current collector 420 (positive electrode current collector) at its second end portion 206 in the X direction. Second electrode assembly 202 includes a positive electrode tab group 280. Positive electrode tab group 280 is electrically connected to current collector 420 (positive electrode current collector) at its fourth end portion 208 in the X direction.

Positive electrode tab group 250 has a curved portion 251 and a tip portion 252. Curved portion 251 is a portion at which positive electrode tab group 250 is curved on the side, on which the second electrode is connected, with respect to tip portion 252. Tip portion 252 is a portion located at an end portion of positive electrode tab group 250 on the side opposite to the side on which the second electrode is connected.

Positive electrode tab group 280 has a curved portion 281 and a tip portion 282. Curved portion 281 is a portion at which positive electrode tab group 280 is curved on the side, on which the second electrode is connected, with respect to tip portion 282. Tip portion 282 is a portion located at an end portion of positive electrode tab group 280 on the side opposite to the side on which the second electrode is connected.

Positive electrode tab group 250 and positive electrode tab group 280 are curved in opposite directions such that tip portions 252, 282 are close to each other. It should be noted that tip portions 252, 272 are separated from each other in the present embodiment; however, it is not limited to this configuration, and tip portions 252, 282 may be in contact with each other.

Positive electrode current collector 400B electrically connects positive electrode terminal 302 to positive electrode tab group 250 and positive electrode tab group 280. Positive electrode current collector 400B in the present embodiment is connected to positive electrode terminal 302 between electrode assembly 200 and sealing plate 130.

Positive electrode current collector 400B includes a current collector 420 and a current collector 450.

Current collector 420 is a plate-shaped member. Current collector 420 has a long-side direction in the Z direction and a short-side direction in the Y direction. Current collector 420 is constituted of a single component in one piece.

Positive electrode tab group 250 and positive electrode tab group 280 are joined, at below-described joining locations 421, to current collector 420 constituted of the single component. Each of joining locations 421 may be formed by ultrasonic welding, resistance welding, laser welding, swaging, or the like, for example. In the present embodiment, positive electrode tab group 250 and positive electrode tab group 280 are joined to current collector 420 by ultrasonic joining, for example.

Current collector 450 is joined to current collector 420 at a joining location (not shown) located at its end portion in the Z direction. Current collector 450 is connected to positive electrode terminal 302. The connection between current collector 450 and positive electrode terminal 302 may be formed by swaging and/or welding, for example.

Positive electrode terminal 302 is provided to be exposed to the outside of sealing plate 130 and reach current collector 450 of positive electrode current collector 400B provided on the inner surface side of sealing plate 130. Positive electrode terminal 302 is connected to a plate-shaped member 304.

Plate-shaped member 304 is located on the outer side with respect to sealing plate 130. Plate-shaped member 304 is disposed along sealing plate 130. Plate-shaped member 304 has electric conductivity. Plate-shaped member 304 is disposed to secure an area of connection with a bus bar or the like that electrically connects secondary battery 1 and another secondary battery adjacent thereto. The connection between positive electrode terminal 302 and plate-shaped member 304 may be formed by, for example, laser welding or the like.

An insulating member 510 is disposed between plate-shaped member 304 and sealing plate 130. An insulating member 520 is disposed between positive electrode terminal 302 and sealing plate 130. An insulating member 530 is disposed between current collector 450 and sealing plate 130.

It should be noted that positive electrode terminal 302 may be electrically connected to sealing plate 130. Further, sealing plate 130 may function as positive electrode terminal 302.

A spacer 600 is disposed between sealing plate 130 and the main body portion (positive electrode tab groups 250, 280 are not included) of electrode assembly 200. Spacer 600 is composed of a resin member having an insulating property. Spacer 600 includes a first component 610 and a second component 620. First component 610 and second component 620 are engaged with each other at engagement portions (not shown) at both ends in the Z direction.

Each of first component 610 and second component 620 protrudes in the Y direction at its end portion side on the electrode assembly 200 side in the X direction. Thus, spacer 600 functions as a guide to facilitate curving of curved portions 251, 281 when forming curved portions 251, 281.

Insulating sheet 700 (electrode assembly holder) composed of a resin is disposed between electrode assembly 200 and case main body 110.

### (Configuration of Battery Assembly)

FIG. 11 is a perspective view of a battery assembly according to one embodiment. As shown in FIG. 11, in the battery assembly, the plurality of secondary batteries 1 are arranged in the Y direction. The plurality of secondary batteries 1 are disposed such that first side surface portions 111 (third wall portions) thereof face each other.

A plate member 800 (adjacent member) is disposed on second side surface portions 112B in each of which gas-discharge valve 150 is provided. The upper surface (first surface) of plate member 800 faces second side surface portions 112B of secondary batteries 1.

Groove portions 810 are formed in the upper surface of plate member 800. A space 820 is formed in plate member 800 at a portion facing each gas-discharge valve 150. Space 820 may be formed by providing a through hole in plate member 800, or may be formed by providing a recess facing gas-discharge valve 150 in plate member 800 (in this case, the recess extends in, for example, the Y direction and communicates with an external space so as to function as a gas duct). Alternatively, plate member 800 may be divided into two and space 820 may be provided therebetween. In any case, space 820 is formed at the portion facing gas-discharge valve 150. Further, each of groove portions 810 communicates with space 820 facing gas-discharge valve 150.

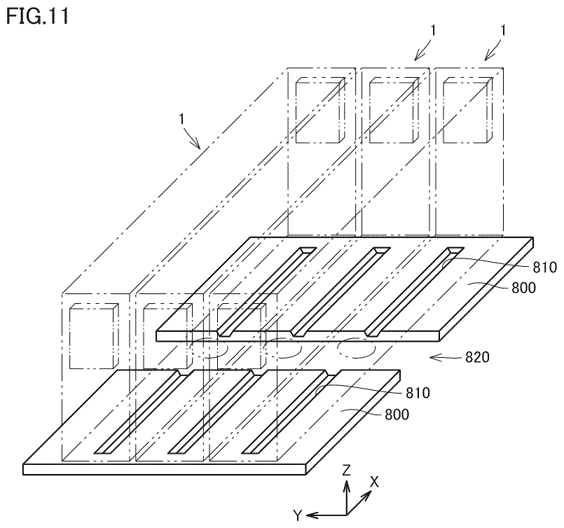

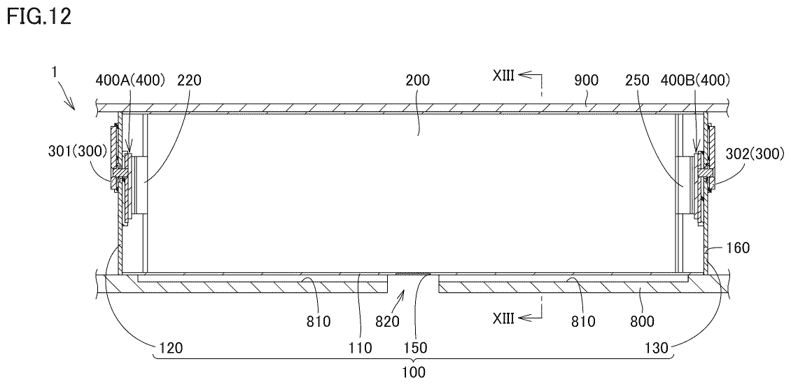

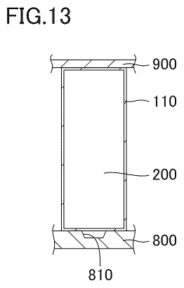

FIG. 12 is a front cross sectional view of secondary battery 1 and plate members 800, 900, and FIG. 13 is a cross sectional view along XIII-XIII in FIG. 12.

As shown in FIGS. 12 and 13, plate member 900 (second adjacent member) is disposed on the outer surface side of second side surface portion 112A (second wall portion) constituting the upper surface portion of case main body 110. Plate members 800, 900 are disposed to extend in parallel in the stacking direction (Y direction) of secondary batteries 1.

Case 100 and each of plate members 800, 900 may be in direct contact with each other, or may be indirectly in abutment with each other with another member such as an insulating film or a sheet being interposed therebetween, for example. Further, case 100 may be covered with a resin film.

The thickness of case main body 110 constituting each of second side surface portions 112A, 112B is preferably about 0.1 mm or more and 1 mm or less (more preferably 0.7 mm or less).

Plate member 800 is preferably composed of a metal, and the thickness thereof (portion at which no groove portion 810 is formed) is more preferably about 1 mm or more (more preferably 3 mm or more) and 10 mm or less.

Preferably, each of case main body 110 and plate member 800 is composed of a metal, and the thickness of second side surface portion 112B of case main body 110 is equal to or less than the thickness of the portion of plate member 800 at which no groove portion 810 is formed.

It should be noted that the materials, thicknesses, and the like of case main body 110 and plate member 800 are not limited to the above-described ranges, and can be appropriately changed. Further, for example, a block-shaped member may be disposed as the adjacent member instead of each of plate members 800, 900.

Further, plate member 900 (second adjacent member) adjacent to second side surface portion 112A may not necessarily be provided.

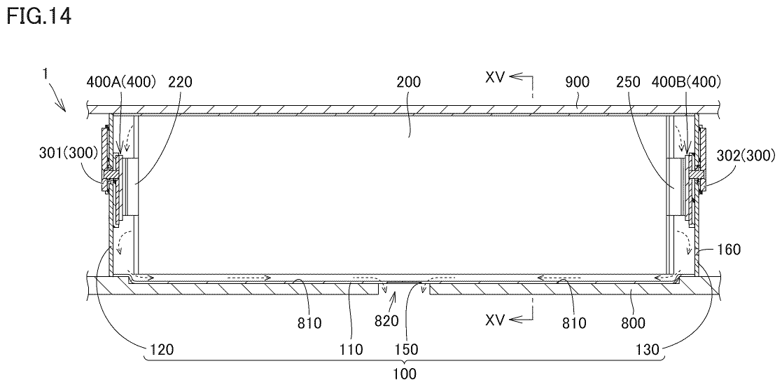

FIG. 14 is a front cross sectional view of secondary battery 1 and plate members 800, 900 in a state in which internal pressure of case 100 is increased to operate gas-discharge valve 150, and FIG. 15 is a cross sectional view along XV-XV in FIG. 14.

When the pressure in case 100 is increased, a portion of case 100 not restrained by the adjacent member is expanded. In the battery assembly according to the present embodiment, since groove portion 810 is provided in plate member 800 adjacent to second side surface portion 112B of case 100, a portion of the bottom surface portion (second side surface portion 112B) of case main body 110 is deformed to outside of case 100 along groove portion 810 as shown in FIGS. 14 and 15.

In the example of the present embodiment, as shown in FIG. 14, when viewed in the Z direction (second direction), groove portion 810 is formed to reach a portion of the upper surface (first surface) of plate member 800 that does not overlap with electrode assembly 200, i.e., to reach each of regions close to sealing plates 120, 130 with respect to the end surfaces of the main body portion (other than the tab portion) of electrode assembly 200 in the X direction. Therefore, as indicated by arrows in FIG. 14, a path is secured such that the gas discharged from the end surface of the main body portion of electrode assembly 200 in the X direction flows from the space between the main body portion of electrode assembly 200 and each of sealing plates 120, 130 to a clearance formed between electrode assembly 200 formed along groove portion 810 and the bottom surface portion (second side surface portion 112B) of case main body 110 and reaches gas-discharge valve 150.

Since the deformation of second side surface portion 112B occurs before the pressure (first pressure value) at which gas-discharge valve 150 is fractured is reached (since case main body 110 is deformed at a lower pressure), a space along groove portion 810 can be formed in case 100 between the inner surface of case main body 110 and electrode assembly 200, thereby securing a discharge path connected to gas-discharge valve 150. As a result, case 100 can be suppressed from being fractured to be opened at an unintended location and gas-discharge valve 150 can be stably operated, thereby obtaining a battery assembly having high reliability.

In the example of the present embodiment, the pair of first side surface portions 111 in case main body 110 are restrained by adjacent secondary batteries 1, and the upper surface portion (second side surface portion 112A) of case main body 110 is restrained by plate member 900. Further, the thickness of each of sealing plates 120, 130 is larger than the thickness of second side surface portion 112B of case main body 110. Therefore, when the internal pressure of case 100 is increased, the portion of the bottom surface portion (second side surface portion 112B) of case main body 110 not restrained by plate member 800 is likely to be deformed early to the outside.

It should be noted that the scope of the present technology is not limited thereto, and a wall surface other than the bottom surface portion (second side surface portion 112B) of case main body 110 may not necessarily be restrained, and the thickness of each of sealing plates 120, 130 may be equal to or less than the thickness of second side surface portion 112B.

### (Exemplary Arrangements of Groove Portions 810)

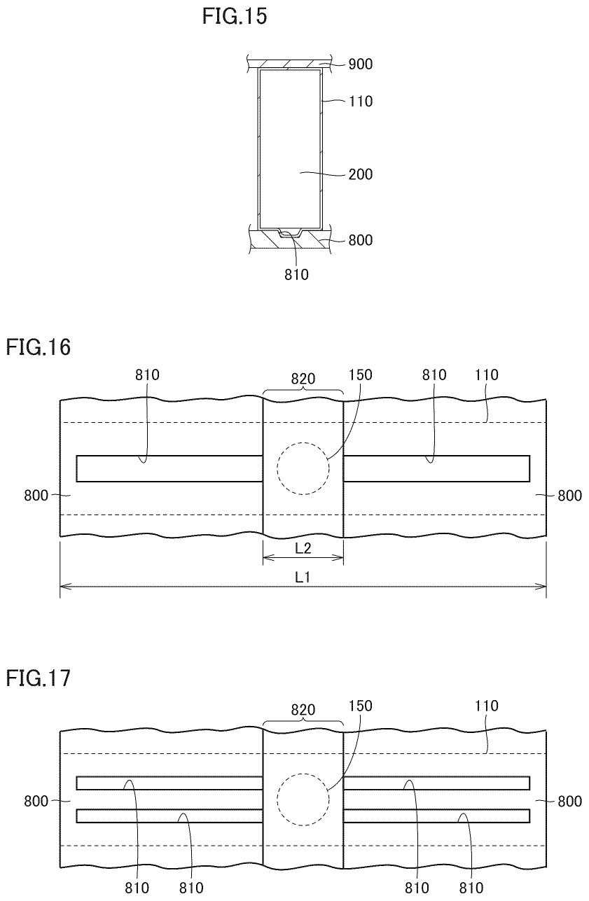

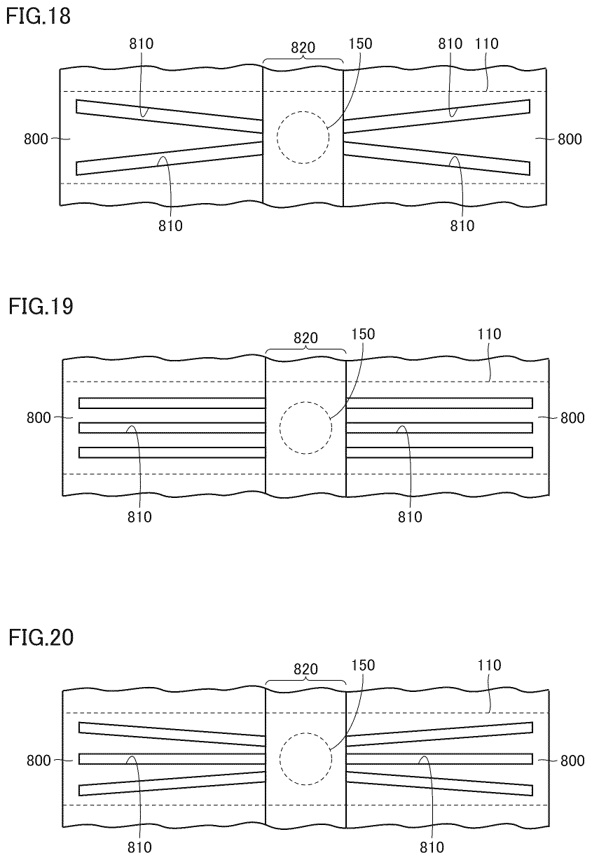

Each of FIGS. 16 to 20 is a diagram showing an exemplary arrangement of groove portions 810. As shown in FIGS. 16 to 20, one row of groove portions 810 may be provided in one case main body 110 (FIG. 16) or a plurality of rows of groove portions 810 may be provided in one case main body 110 (FIGS. 17 to 20). Groove portions 810 may extend in the width direction (X direction) of secondary battery 1 (FIGS. 16, 17, and 19) or may extend in oblique directions obliquely intersecting the X direction (FIG. 18), or groove portions 810 extending in the X direction and groove portions 810 extending in the oblique directions may be combined (FIG. 20). It should be noted that the arrangements of groove portions 810 are not limited to those illustrated in FIGS. 16 to 20.

At least a portion of gas-discharge valve 150 is preferably disposed at the central region of second side surface portion 112B. It should be noted that the “central region” herein means a region within ±10% of the entire length of case 100 in the X direction from the center of case 100 in the X direction, i.e., a region of 40% or more and 60% or less of the entire length (L1) of case 100 in the X direction from the end portion of case 100 (L2≤1/5L1).

A thin portion having a circular shape and constituting gas-discharge valve 150 may be formed to have a flat shape or may be formed to have a dome shape. Further, gas-discharge valve 150 may be constituted of, for example, a groove having an annular shape or a groove having a shape of line (such as a lateral line, a longitudinal line, or a cross), rather than the thin portion having a circular shape.

In each of the examples of FIGS. 16 to 20, the entire length of case 100 in the X direction and the width of plate member 800 in the X direction substantially coincide with each other, but the width of plate member 800 in the X direction may be longer than the entire length (L1) of case 100 or may be shorter than the entire length (L1) of case 100.

### (Cross Sectional Shape of Groove Portion 810)

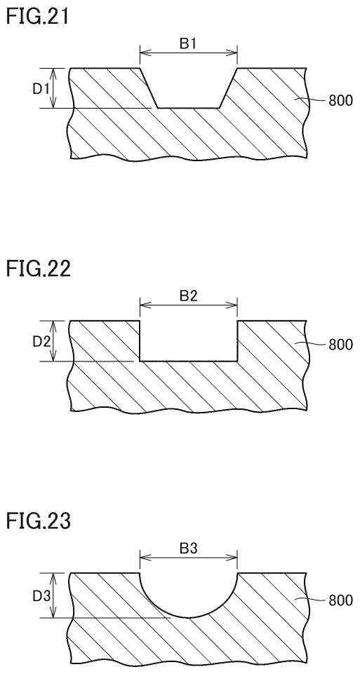

Each of FIGS. 21 to 23 shows an exemplary cross sectional shape of groove portion 810. As shown in FIGS. 21 to 23, the cross sectional shape of groove portion 810 may be an inverted trapezoidal shape (FIG. 21), a rectangular shape (FIG. 22), or an arc shape (FIG. 23). It should be noted that the cross sectional shape of groove portion 810 is not limited to those illustrated in FIGS. 21 to 23.

The width (B1, B2, B3) of groove portion 810 is preferably about 3 mm or more, and is more preferably about 5 mm or more. As one example, the width of groove portion 810 is about 20 mm or less. As one example, the width of groove portion 810 is about 10% or more and 50% or less of the width of case 100 in the thickness direction (Y direction).

The depth (D1, D2, D3) of groove portion 810 is preferably 0.5 mm or more, and is more preferably about 1 mm or more. As one example, the depth of groove portion 810 is about 3 mm or less. As one example, the depth of groove portion 810 is about 50% or more and 300% or less of the thickness of second side surface portion 112B (portion other than gas-discharge valve 150) of case main body 110.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery assembly comprising:
a plurality of prismatic secondary batteries arranged in a first direction; and
an adjacent member disposed on each of the prismatic secondary batteries, wherein
the prismatic secondary battery includes an electrode assembly including a positive electrode and a negative electrode, and a battery case that accommodates the electrode assembly,
the battery case includes a first wall portion and a second wall portion facing each other in a second direction orthogonal to the first direction,
the first wall portion is provided with a gas-discharge valve that is fractured when pressure in the battery case becomes equal to or more than a first pressure value so as to discharge gas in the battery case to outside of the battery case,
the adjacent member has a first surface facing an outer surface of the first wall portion,
a space is formed in the adjacent member at a position facing the gas-discharge valve,
a groove portion communicating with the space is formed in the first surface of the adjacent member, and
when the pressure in the battery case is increased, a portion of the first wall portion is deformed to the outside of the battery case along the groove portion before reaching the first pressure value at which the gas-discharge valve is fractured.

2. The battery assembly according to claim 1, wherein
the battery case includes a pair of third wall portions facing each other in the first direction, and
the plurality of prismatic secondary batteries are disposed such that the third wall portions of the plurality of prismatic secondary batteries face each other.

3. The battery assembly according to claim 1, further comprising a second adjacent member disposed on an outer surface side of the second wall portion.

4. The battery assembly according to claim 1, wherein
the battery case includes a pair of third wall portions facing each other in the first direction, and
the plurality of prismatic secondary batteries are disposed such that the third wall portions of the plurality of prismatic secondary batteries face each other,
the battery assembly further comprising a second adjacent member disposed on an outer surface side of the second wall portion.

5. The battery assembly according to claim 1, wherein the groove portion is formed to reach a portion of the first surface that does not overlap with the electrode assembly when viewed in the second direction.

6. The battery assembly according to claim 1, wherein
the battery case includes a pair of third wall portions facing each other in the first direction,
the plurality of prismatic secondary batteries are disposed such that the third wall portions of the plurality of prismatic secondary batteries face each other, and
the groove portion is formed to reach a portion of the first surface that does not overlap with the electrode assembly when viewed in the second direction.

7. The battery assembly according to claim 1, further comprising a second adjacent member disposed on an outer surface side of the second wall portion, wherein
the groove portion is formed to reach a portion of the first surface that does not overlap with the electrode assembly when viewed in the second direction.

8. The battery assembly according to claim 1, wherein
the battery case includes a pair of third wall portions facing each other in the first direction, and
the plurality of prismatic secondary batteries are disposed such that the third wall portions of the plurality of prismatic secondary batteries face each other,
the battery assembly further comprising a second adjacent member disposed on an outer surface side of the second wall portion, wherein
the groove portion is formed to reach a portion of the first surface that does not overlap with the electrode assembly when viewed in the second direction.

9. The battery assembly according to claim 1, wherein
each of the battery case and the adjacent member is composed of a metal, and
a thickness of the first wall portion of the battery case is equal to or less than a thickness of a portion of the adjacent member in which the groove portion is not formed.

10. The battery assembly according to claim 1, wherein
the battery case includes a pair of third wall portions facing each other in the first direction,
the plurality of prismatic secondary batteries are disposed such that the third wall portions of the plurality of prismatic secondary batteries face each other,
each of the battery case and the adjacent member is composed of a metal, and
a thickness of the first wall portion of the battery case is equal to or less than a thickness of a portion of the adjacent member in which the groove portion is not formed.

11. The battery assembly according to claim 1, further comprising a second adjacent member disposed on an outer surface side of the second wall portion, wherein
each of the battery case and the adjacent member is composed of a metal, and
a thickness of the first wall portion of the battery case is equal to or less than a thickness of a portion of the adjacent member in which the groove portion is not formed.

12. The battery assembly according to claim 1, wherein
the groove portion is formed to reach a portion of the first surface that does not overlap with the electrode assembly when viewed in the second direction,
each of the battery case and the adjacent member is composed of a metal, and
a thickness of the first wall portion of the battery case is equal to or less than a thickness of a portion of the adjacent member in which the groove portion is not formed.

13. The battery assembly according to claim 1, wherein
the battery case includes a pair of third wall portions facing each other in the first direction, and
the plurality of prismatic secondary batteries are disposed such that the third wall portions of the plurality of prismatic secondary batteries face each other,
the battery assembly further comprising a second adjacent member disposed on an outer surface side of the second wall portion, wherein
each of the battery case and the adjacent member is composed of a metal, and
a thickness of the first wall portion of the battery case is equal to or less than a thickness of a portion of the adjacent member in which the groove portion is not formed.

14. The battery assembly according to claim 1, wherein
the battery case includes a pair of third wall portions facing each other in the first direction,
the plurality of prismatic secondary batteries are disposed such that the third wall portions of the plurality of prismatic secondary batteries face each other,
the groove portion is formed to reach a portion of the first surface that does not overlap with the electrode assembly when viewed in the second direction,
each of the battery case and the adjacent member is composed of a metal, and
a thickness of the first wall portion of the battery case is equal to or less than a thickness of a portion of the adjacent member in which the groove portion is not formed.

15. The battery assembly according to claim 1, further comprising a second adjacent member disposed on an outer surface side of the second wall portion, wherein
the groove portion is formed to reach a portion of the first surface that does not overlap with the electrode assembly when viewed in the second direction,
each of the battery case and the adjacent member is composed of a metal, and
a thickness of the first wall portion of the battery case is equal to or less than a thickness of a portion of the adjacent member in which the groove portion is not formed.

16. The battery assembly according to claim 1, wherein
the battery case includes a pair of third wall portions facing each other in the first direction, and
the plurality of prismatic secondary batteries are disposed such that the third wall portions of the plurality of prismatic secondary batteries face each other,
the battery assembly further comprising a second adjacent member disposed on an outer surface side of the second wall portion, wherein
the groove portion is formed to reach a portion of the first surface that does not overlap with the electrode assembly when viewed in the second direction,
each of the battery case and the adjacent member is composed of a metal, and
a thickness of the first wall portion of the battery case is equal to or less than a thickness of a portion of the adjacent member in which the groove portion is not formed.

17. The battery assembly according to claim 1, wherein
the battery case includes a case main body provided with an opening, and a sealing plate that seals the opening, and
the gas-discharge valve is provided in the case main body.

18. The battery assembly according to claim 1, wherein
the battery case includes a pair of third wall portions facing each other in the first direction, and
the plurality of prismatic secondary batteries are disposed such that the third wall portions of the plurality of prismatic secondary batteries face each other,
the battery assembly further comprising a second adjacent member disposed on an outer surface side of the second wall portion, wherein
the groove portion is formed to reach a portion of the first surface that does not overlap with the electrode assembly when viewed in the second direction,
each of the battery case and the adjacent member is composed of a metal,
a thickness of the first wall portion of the battery case is equal to or less than a thickness of a portion of the adjacent member in which the groove portion is not formed,
the battery case includes a case main body provided with an opening, and a sealing plate that seals the opening, and
the gas-discharge valve is provided in the case main body.
